(19) United States
(12) Patent Application Publication
(10) Pub. No.: US 2026/0044520 A1
(43) Pub. Date: Feb. 12, 2026

(54) AUTOMATIC IDENTIFICATION AND TRACKING OF STABLE OBJECTS

(71) Applicant: Snowflake Inc., Bozeman, MT (US)

(72) Inventors: Michael Hornstein, Sunnyvale, CA (US); Rudi M. Leibbrandt, Danville, CA (US); Louis Magarshack, San Francisco, CA (US); Jiaqi Yan, Menlo Park, CA (US)

(21) Appl. No.: 18/799,050

(22) Filed: Aug. 9, 2024

(51) Int. Cl. G06F 16/2458; G06F 11/34; G06F 16/22; G06F 16/25

(52) U.S. Cl. CPC G06F 16/2462; G06F 11/3414; G06F 16/2228; G06F 16/256

(57) ABSTRACT

Methods, systems, and computer programs are presented for providing performance metrics in an online performance analysis system employing customer objects, such as database tables. A plurality of metric source data associated with a plurality of objects is accessed and a subset of the plurality of objects is determined that satisfies stableness criteria based on the plurality of metric source data to identify a set of stable objects. A set of metrics is generated based on the subset of the plurality of objects that satisfies the stableness criteria.

### TECHNICAL FIELD

The present disclosure generally relates to special-purpose machines that manage data platforms and databases and, more specifically, data platforms for identifying system performance over time and generating a set of metrics, such as indices and benchmarks.

### BACKGROUND

Network-based database systems may be provided through a cloud data platform, which allows organizations, customers, and users to store, manage, and retrieve data from the cloud. With respect to type of data processing, a cloud data platform could implement online transactional processing, online analytical processing, a combination of the two, and/or other types of data processing. Moreover, a cloud data platform could be or include a relational database management system and/or one or more other types of database management systems.

One such example is a cloud data warehouse (also referred to as a “network-based data warehouse,” “virtual data warehouse,” or simply as a “data warehouse”), which is a cloud data platform used for data analysis and reporting that comprises a central repository of integrated data from one or more disparate sources. A data warehouse can store current and historical data that can be used for creating analytical reports for an enterprise. To this end, data warehouses can provide business intelligence tools, tools to extract, transform, and load data into the repository, and tools to manage and retrieve metadata.

### BRIEF DESCRIPTION OF THE DRAWINGS

Various ones of the appended drawings merely illustrate examples of the present disclosure and should not be considered as limiting its scope.

FIG. 1 illustrates an example computing environment in which a cloud data platform is in communication with a cloud storage provider system, according to some examples.

FIG. 2 is a block diagram illustrating components of a compute service manager, according to some examples.

FIG. 3 is a block diagram illustrating components of an execution platform, according to some examples.

FIG. 4 is a block diagram illustrating components of a stable object index service, according to some examples.

FIG. 5 illustrates an aspect of the subject matter in accordance with one example.

FIG. 6 illustrates a routine (method or process) in accordance with one example.

FIG. 7 illustrates a diagrammatic representation of a machine in the form of a computer system within which a set of instructions can be executed for causing the machine to perform any one or more of the methodologies discussed herein, in accordance with some examples of the present disclosure.

### DETAILED DESCRIPTION

The description that follows includes systems, methods, techniques, instruction sequences, and computing machine program products that embody illustrative examples of the disclosure. In the following description, for the purposes of explanation, numerous specific details are set forth in order to provide an understanding of various examples of the inventive subject matter. It will be evident, however, to those skilled in the art, that examples of the inventive subject matter can be practiced without these specific details. In general, well-known instruction instances, protocols, structures, and techniques are not necessarily shown in detail.

Examples of the present disclosure include the generation of a performance index or one or more metrics by leveraging the functionality of a cloud data platform to provide near real-time analysis of metrics for customers and users of the platform based on real production workloads of stable objects, such as stable tables. The cloud data platform provides for application developers, data scientists, and data engineers to develop data pipelines and products by employing data engineering, data science, and data warehousing. The cloud data platform performance index creates an index to capture any or all aspects of system performance for stable objects over a period time while being sensitive to product improvements, changes, updates, and the like. More specifically, examples provide a stable and reliable solution to track, measure, compare, and analyze query performance changes of real production workloads on stable objects over extended periods of time along arbitrary dimensions and performance metrics using performance indexing. This enables the system to track cost and efficiency and determine price-performance information. For the purposes of this description, the phrase “a cloud data platform performance index” may be referred to as and used interchangeably with the phrases “an index system,” “a performance index,” “a performance index service,” “performance-as-a-product service,” “global index,” “sub-index,” “metric,” “benchmark,” or merely “an index.”

Traditional approaches for tracking performance include using a fixed set of synthetic (e.g., artificially generated) benchmarks with predefined performance metrics that can be consistently tracked, where these benchmarks are designed to stress specific aspects of a system and are not always representative of real-world performance. Alternative conventional systems attempt to leverage natural experiments to recognize invariant aspects of production workloads (e.g., features that remain constant and unchanged) that can be used for comparison over time regardless of specific inputs, conditions, and/or actual workloads. However, both traditional approaches fail to be representative of a customer's production workloads that are affected by variations in input data, factor changes, and/or other workload updates. Thus, conventional systems fail to capture customer's performance experiences on a cloud data platform using real-time or near real-time data. Even still, conventional systems track performance arbitrarily across a sample set of data, all of the data, or user specified data or objects. This can create inaccuracies as some data can vastly differ in composition and behavior from other data which creates outliers. These outliers can adversely influence the performance that is tracked and can cause unnecessary system downtime and increased cost. Thus, synthetic benchmarks are not sufficient to capture and analyze performance of a cloud data platform's real-world production queries and workloads for objects that are representative of the entire database system, such as stable objects or stable tables.

Performance metrics for cloud data platforms typically include measures of throughput, scalability, reliability, cost, and the like. However, with current infrastructure and metrics available today, it is difficult to evaluate many aspects of cloud data platform performance as it corresponds to real-world production (e.g., actual customer workloads). Performance numbers collected and aggregated across the cloud data platform deployments tend to be very unstable and are not useful for measuring global performance trends. Conventional systems are insensitive to variations in customer workloads and object sizes, as there are no existing methods and system for tracking performance trends over an extended period of time (e.g., over quarters to multiple years) for a specific set of objects (e.g., stable objects) since workloads tend to change over time, causing performance numbers to be incomparable over a longer period of time.

Currently, for many performance improvements, the random variations or errors in data (e.g., noise) is so large it often obscures underlying patterns, relationships, and/or measurable performance improvements leading to inaccurate or unreliable results. Thus, it is impossible to accurately measure the impact of a specific change to production workloads. Furthermore, conventional systems fail to compare performance of a database over extended periods of time by simply comparing two endpoints (e.g., a beginning state and an end state) when workloads typically have changed significantly with a small degree of overlap.

Examples of the present disclosure improve upon existing models and overcome such current technical challenges by providing a stable and reliable system to measure and compare database performance changes based on real production workloads over extended periods of time for a specific set of stable objects or categories of stable objects, including analysis along arbitrary dimensions and performance metrics. Thus, examples of the present disclosure solve the technical problem relating to performance tracking by allowing for accurate assessments of the impact of each specific change to production workloads by building performance metrics that are based on database objects that are determined to be stable (e.g., stable objects) in the cloud data platform performance.

Specifically, the disclosed examples access, by at least one hardware processor, a plurality of metric source data associated with a plurality of objects and determine that a subset of the plurality of objects satisfies stableness criteria based on the plurality of metric source data to identify a set of stable objects. The disclosed examples generate a set of metrics based on the subset of the plurality of objects that satisfies the stableness criteria. The plurality of metric source data can indicate the number of rows added to each of the plurality of objects over a specified time period.

In some examples, the plurality of metric source data indicates the number of rows deleted from each of the plurality of objects over the specified time period. In some cases, the stableness criteria includes a table size criterion and a table churn criterion. The disclosed examples determine that an individual object of the subset of the plurality of objects satisfies the table size criterion based on a plurality of dimensions. The plurality of dimensions can include a growth rate dimension, a variation in the growth rate dimension, and a size of the object dimension. The size of the object dimension can represent a magnitude of a number of rows on any given day during the specified time period.

In some examples, the disclosed examples compute the growth rate dimension of the individual object as a function of a net change in a number of rows of the individual object over the specified time period and classify the individual object into an individual category of a plurality of growth categories based on the computed growth rate dimension. The disclosed examples compute the variation in the growth rate dimension based on a coefficient of variation of daily differences in the change in the number of rows. The disclosed examples compute a total number of rows inserted on each day of the specified time period and compute an average of the total number of rows inserted on each day of the specified time period. The disclosed examples compute a standard deviation of the total number of rows inserted on each day of the specified time period and compute a ratio of the standard deviation to the average to compute the coefficient of the variation of the daily differences in the change in the number of rows.

In some cases, the disclosed examples determine that the individual object is a stable object in response to determining that an amount of the growth rate dimension is below a first threshold and the variation in the growth rate dimension is below a second threshold. Different orders of magnitude can be used to categorize the individual object based on the size of the object dimension. In some examples, the disclosed examples determine that an individual object of the subset of the plurality of objects satisfies the table churn criterion based on a number of rows inserted versus number of rows deleted over the specified time period. The disclosed examples classify churn of the individual object based on an amount of churn value and a fraction of churn value. In some cases, the disclosed examples compute the amount of churn value by determining how many rows were inserted and how many rows were deleted from the object and compute the fraction of churn value based on a number of rows that were inserted divided by a total of the number of rows that were inserted and a number of rows that were deleted.

The disclosed examples assign a first churn category to the individual object in response to determining that the amount of churn value is below a first threshold and assign a second churn category to the individual object in response to determining that the amount of churn value is between the first threshold and a second threshold. The disclosed examples assign a third churn category to the individual object in response to determining that the fraction of churn value is below a third threshold and assign a fourth churn category to the individual object in response to determining that the fraction of churn value is between the third threshold and a fourth threshold.

In some examples, the disclosed examples cause a portion of the set of metrics to be displayed in a user interface. Each stable object in the set of stable objects can include a composition that remains stable or changes at a stable rate over a specified time period. In some cases, the disclosed examples generate a set of indexes as the set of metrics to represent functions of a database system and identify categories of the plurality of objects for generating new features in the database system. The disclosed examples can generate a set of benchmarks for a database system based on the set of metrics.

Identifying stable objects enables the system to measure performance improvements on objects for which the composition remains consistent over time. Using the stable objects, the system is able to increase the power of hypothesis tests when detecting changes in metrics. This is because stable objects exhibit little variation in their behavior over time and the signal-to-noise ratio is higher when comparing metrics before vs. after an engineering rollout. Stable objects can be used to target indexing and feature analysis and development.

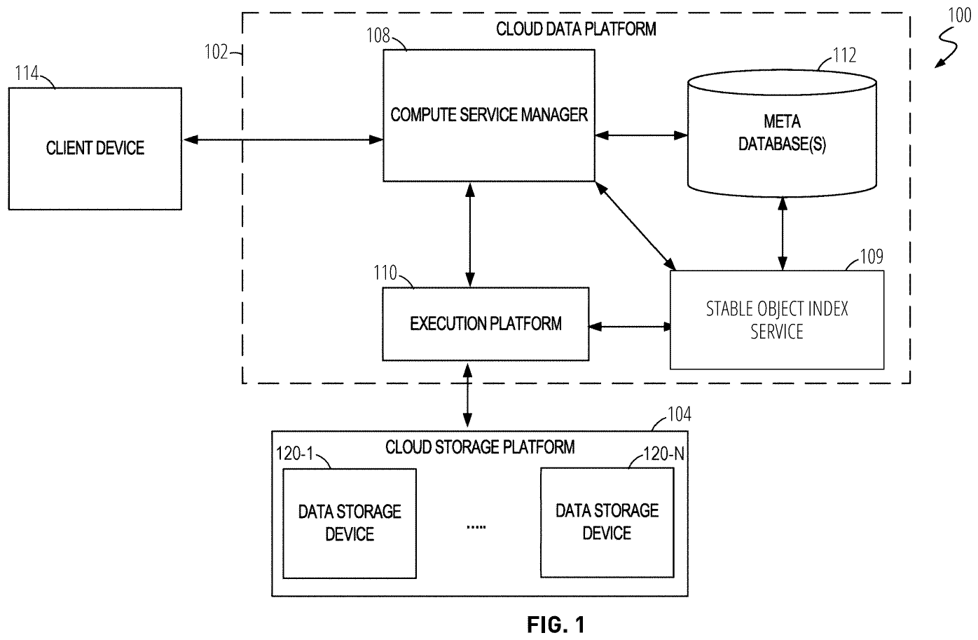

FIG. 1 illustrates an example computing environment 100 that includes a database system in the example form of a cloud data platform 102, in accordance with some examples of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein. In other examples, the computing environment may comprise another type of network-based database system or a cloud data platform.

As shown, the computing environment 100 comprises the cloud data platform 102 in communication with a cloud storage platform 104 (e.g., AWS®, Microsoft Azure Blob Storage®, or Google Cloud Storage). The cloud data platform 102 is a network-based system used for reporting and analysis of integrated data from one or more disparate sources including one or more storage locations within the cloud storage platform 104. The cloud data platform 102 can be a network-based data platform or network-based data system. The cloud storage platform 104 comprises a plurality of computing machines and provides on-demand computer system resources such as data storage and computing power to the cloud data platform 102.

The cloud data platform 102 comprises a compute service manager 108, an execution platform 110, and one or more metadata databases 112. The cloud data platform 102 hosts and provides data reporting and analysis services to multiple client accounts.

The compute service manager 108 coordinates and manages operations of the cloud data platform 102. The compute service manager 108 also performs query optimization and compilation as well as managing clusters of computing services that provide compute resources (also referred to as “virtual warehouses”). The compute service manager 108 can support any number of client accounts such as end users providing data storage and retrieval requests, system administrators managing the systems and methods described herein, and other components/devices that interact with compute service manager 108.

The compute service manager 108 is also in communication with a client device 114. The client device 114 corresponds to a user of one of the multiple client accounts supported by the cloud data platform 102. A user may utilize the client device 114 to submit data storage, retrieval, and analysis requests to the compute service manager 108.

The compute service manager 108 is also coupled to one or more metadata databases 112 that store metadata pertaining to various functions and aspects associated with the cloud data platform 102 and its users. For example, a metadata database 112 may include a summary of data stored in remote data storage systems as well as data available from a local cache. Additionally, a metadata database 112 may include information regarding how data is organized in remote data storage systems (e.g., the cloud storage platform 104) and the local caches. Information stored by a metadata database 112 allows systems and services to determine whether a piece of data needs to be accessed without loading or accessing the actual data from a storage device.

The compute service manager 108 is further coupled to the execution platform 110, which provides multiple computing resources that execute various data storage and data retrieval tasks. The execution platform 110 is coupled to cloud storage platform 104. The cloud storage platform 104 comprises multiple data storage devices 120-1 to 120-N. In some examples, the data storage devices 120-1 to 120-N are cloud-based storage devices located in one or more geographic locations. For example, the data storage devices 120-1 to 120-N can be part of a public cloud infrastructure or a private cloud infrastructure. The data storage devices 120-1 to 120-N may be hard disk drives (HDDs), solid state drives (SSDs), storage clusters, Amazon S3™ storage systems, or any other data storage technology. Additionally, the cloud storage platform 104 may include distributed file systems (such as Hadoop Distributed File Systems (HDFS)), object storage systems, and the like.

The execution platform 110 comprises a plurality of compute nodes. A set of processes on a compute node executes a query plan compiled by the compute service manager 108. The set of processes can include: a first process to execute the query plan; a second process to monitor and delete cache files using a least recently used (LRU) policy and implement an out of memory (OOM) error mitigation process; a third process that extracts health information from process logs and status to send back to the compute service manager 108; a fourth process to establish communication with the compute service manager 108 after a system boot; and a fifth process to handle all communication with a compute cluster for a given job provided by the compute service manager 108 and to communicate information back to the compute service manager 108 and other compute nodes of the execution platform 110.

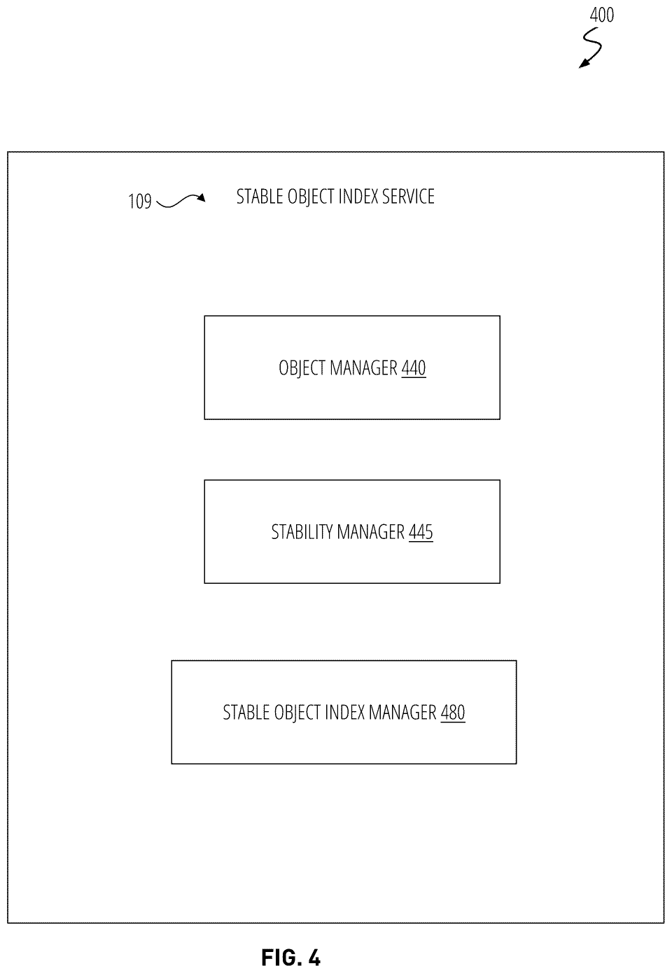

The compute service manager 108, metadata database(s) 112, and execution platform 110 are operatively connected to a stable object index service 109, which provides for the monitoring and determination of stable objects (e.g., stable tables) on the cloud data platform 102 and generation of a collection of performance metrics related to the stable objects and/or workloads performed with respect to the stable objects. The stable object index service 109 can receive metric data related to customer or user workloads or user objects from any of the compute service manager 108, metadata database(s) 112, execution platform 110, or alternative operatively connected modules from within the cloud data platform 102, or externally connected data sources. The stable object index service 109 is depicted and described in combination with FIG. 4.

In some examples, communication links between elements of the computing environment 100 are implemented via one or more data communication networks. These data communication networks may utilize any communication protocol and any type of communication medium. In some examples, the data communication networks are a combination of two or more data communication networks (or sub-Networks) coupled to one another. In alternate examples, these communication links are implemented using any type of communication medium and any communication protocol.

The compute service manager 108, metadata database(s) 112, execution platform 110, stable object index service 109, and cloud storage platform 104 are shown in FIG. 1 as individual discrete components. However, each of the compute service manager 108, metadata database(s) 112, execution platform 110, stable object index service 109, and cloud storage platform 104 can be implemented as a distributed system (e.g., distributed across multiple systems/platforms at multiple geographic locations). Additionally, each of the compute service manager 108, metadata database(s) 112, execution platform 110, stable object index service 109, and cloud storage platform 104 can be scaled up or down (independently of one another) depending on changes to the requests received and the changing needs of the cloud data platform 102. Thus, in the described examples, the cloud data platform 102 is dynamic and supports regular changes to meet the current data processing needs.

During typical operation, the cloud data platform 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a suitable candidate for processing the task. Metadata stored in a metadata database 112 assists the compute service manager 108 in determining which nodes in the execution platform 110 have already cached at least a portion of the data needed to process the task. One or more nodes in the execution platform 110 process the task using data cached by the nodes and, if necessary, data retrieved from the cloud storage platform 104. It is desirable to retrieve as much data as possible from caches within the execution platform 110 because the retrieval speed is typically much faster than retrieving data from the cloud storage platform 104.

As shown in FIG. 1, the computing environment 100 separates the execution platform 110 from the cloud storage platform 104. In this arrangement, the processing resources and cache resources in the execution platform 110 operate independently of the data storage devices 120-1 to 120-N in the cloud storage platform 104. Thus, the computing resources and cache resources are not restricted to specific data storage devices 120-1 to 120-N. Instead, all computing resources and all cache resources may retrieve data from, and store data to, any of the data storage resources in the cloud storage platform 104.

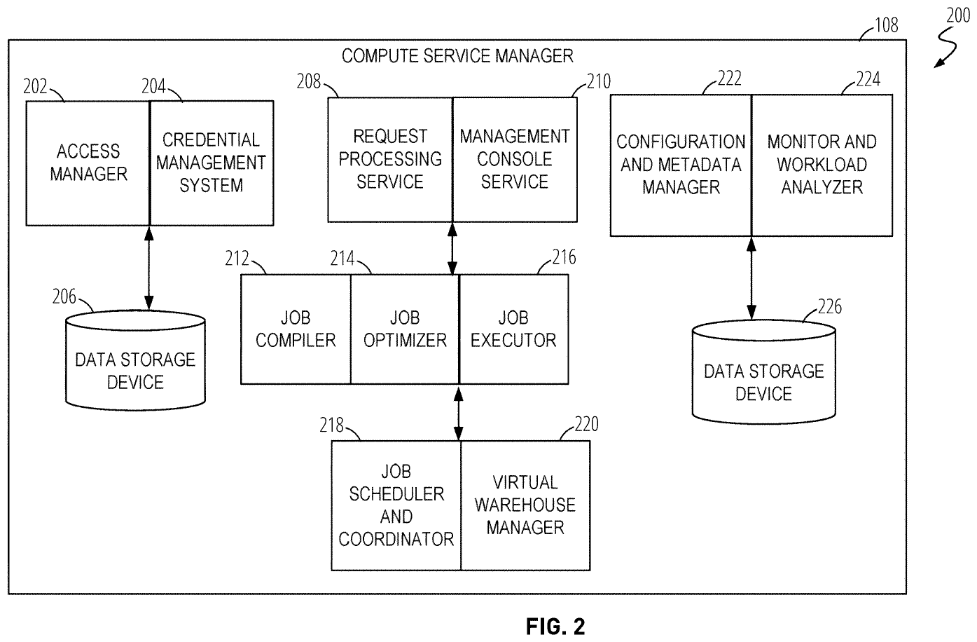

FIG. 2 is a block diagram 200 illustrating components of the compute service manager 108, in accordance with some examples of the present disclosure. As shown in FIG. 2, the compute service manager 108 includes an access manager 202 and a credential management system 204 coupled to data storage device 206, which is an example of the metadata database(s) 112. Access manager 202 handles authentication and authorization tasks for the systems described herein. The credential management system 204 facilitates use of remote stored credentials to access external resources such as data resources in a remote storage device. As used herein, the remote storage devices may also be referred to as “persistent storage devices” or “shared storage devices.” For example, the credential management system 204 may create and maintain remote credential store definitions and credential objects (e.g., in the data storage device 206). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the credential management system 204 and access manager 202 use information stored in the data storage device 206 (e.g., a credential object and a credential store definition) to retrieve security credentials used to access the external resource from a remote credential store.

A request processing service 208 manages received data storage requests and data retrieval requests (e.g., jobs to be performed on database data). For example, the request processing service 208 may determine the data to process a received query (e.g., a data storage request or data retrieval request). The data can be stored in a cache within the execution platform 110 or in a data storage device in cloud storage platform 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs can be prioritized and then processed in that prioritized order. In an example, the job scheduler and coordinator 218 determines a priority for internal jobs that are scheduled by the compute service manager 108 with other “outside” jobs such as user queries that can be scheduled by other systems in the database but may utilize the same processing resources in the execution platform 110. In some examples, the job scheduler and coordinator 218 identifies or assigns particular nodes in the execution platform 110 to process particular tasks. A virtual warehouse manager 220 manages the operation of multiple virtual warehouses implemented in the execution platform 110. For example, the virtual warehouse manager 220 may generate query plans for executing received queries.

Additionally, the compute service manager 108 includes a configuration and metadata manager 222, which manages the information related to the data stored in the remote data storage devices and in the local buffers (e.g., the buffers in execution platform 110). The configuration and metadata manager 222 uses metadata to determine which data files need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the cloud data platform 102 and may further redistribute tasks based on a user (e.g., “external”) query workload that may also be processed by the execution platform 110. The configuration and metadata manager 222 and the monitor and workload analyzer 224 are coupled to a data storage device 226. Data storage device 226 in FIG. 2 represents any data storage device within the cloud data platform 102. For example, data storage device 226 may represent buffers in execution platform 110, storage devices in cloud storage platform 104, or any other storage device.

As described in examples herein, the compute service manager 108 validates all communication from an execution platform (e.g., the execution platform 110) to validate that the content and context of that communication are consistent with the task(s) known to be assigned to the execution platform. For example, an instance of the execution platform executing a query A should not be allowed to request access to data-source D (e.g., data storage device 226) that is not relevant to query A. Similarly, a given execution node (e.g., execution node 302-1) may need to communicate with another execution node (e.g., execution node 302-2), and should be disallowed from communicating with a third execution node (e.g., execution node 312-1) and any such illicit communication can be recorded (e.g., in a log or other location). Also, the information stored on a given execution node is restricted to data relevant to the current query and any other data is unusable, rendered so by destruction or encryption where the key is unavailable.

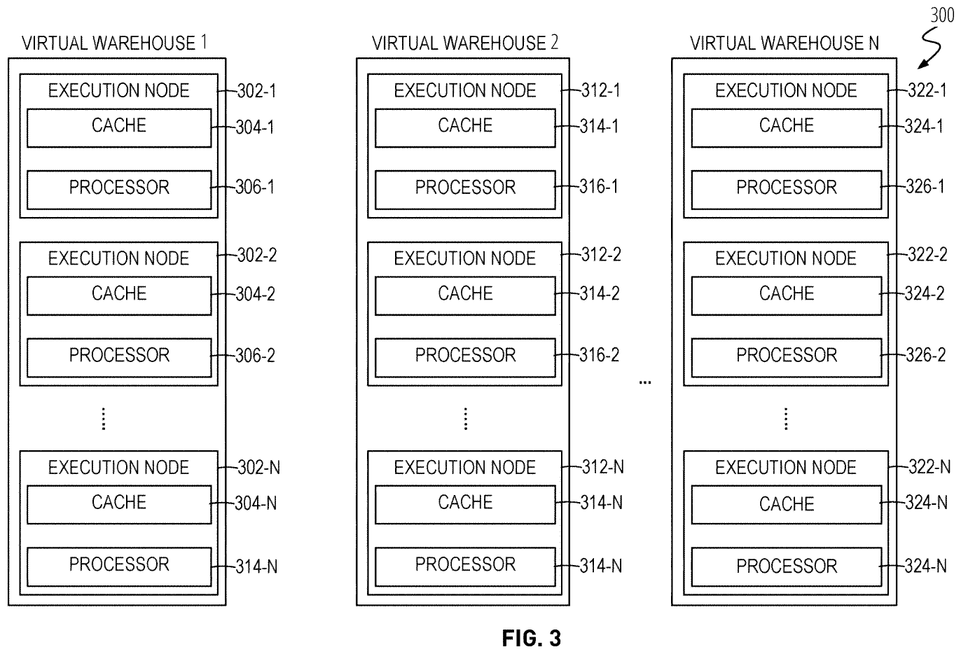

FIG. 3 is a block diagram 300 illustrating components of the execution platform 110, in accordance with some examples of the present disclosure. As shown in FIG. 3, the execution platform 110 includes multiple virtual warehouses, including virtual warehouse 1, virtual warehouse 2, and virtual warehouse N. Each virtual warehouse includes multiple execution nodes that each include a data cache and a processor. The virtual warehouses can execute multiple tasks in parallel by using the multiple execution nodes. As discussed herein, the execution platform 110 can add new virtual warehouses and drop existing virtual warehouses in real-time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in cloud storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer useful.

Each virtual warehouse is capable of accessing any of the data storage devices 120-1 to 120-N shown in FIG. 1. Thus, the virtual warehouses are not necessarily assigned to a specific data storage device 120-1 to 120-N and, instead, can access data from any of the data storage devices 120-1 to 120-N within the cloud storage platform 104. Similarly, each of the execution nodes shown in FIG. 3 can access data from any of the data storage devices 120-1 to 120-N. In some examples, a particular virtual warehouse or a particular execution node can be temporarily assigned to a specific data storage device, but the virtual warehouse or execution node may later access data from any other data storage device.

In the example of FIG. 3, virtual warehouse 1 includes three execution nodes 302-1, 312-1, and 322-1. Execution node 302-1 includes a cache 304-1 and a processor 306-1. Execution node 312-1 includes a cache 314-1 and a processor 316-1. Execution node 322-1 includes a cache 324-1 and a processor 326-1. Each execution node 302-1, 312-1, and 322-1 is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 302-2, 312-2, and 322-1. Execution node 302-2 includes a cache 304-2 and a processor 306-2. Execution node 312-2 includes a cache 314-2 and a processor 316-2. Execution node 322-2 includes a cache 324-2 and a processor 326-2. Additionally, virtual warehouses 1-N include three execution nodes 302-N, 312-N, and 322-N. Execution node 312-N includes a cache 314-N and a processor 314-N. Execution node 322-N includes a cache 324-N and a processor 324-N.

In some examples, the execution nodes shown in FIG. 3 are stateless with respect to the data being cached by the execution nodes. For example, these execution nodes do not store or otherwise maintain state information about the execution node, or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternate examples may include execution nodes containing any number of processors and any number of caches. Additionally, the caches may vary in size among the different execution nodes. The caches shown in FIG. 3 store, in the local execution node, data that was retrieved from one or more data storage devices in cloud storage platform 104. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some examples, the caches are implemented using high-speed memory devices that provide fast access to the cached data. Each cache can store data from any of the storage devices in the cloud storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some examples, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor intensive. Similarly, an execution node may be assigned more cache resources if the tasks performed by the execution node require a larger cache capacity.

Although virtual warehouses 1, 2, and N are associated with the same execution platform 110, the virtual warehouses can be implemented using multiple computing systems at multiple geographic locations. For example, virtual warehouse 1 can be implemented by a computing system at a first geographic location, while virtual warehouses 2 and N are implemented by another computing system at a second geographic location. In some examples, these different computing systems are cloud-based computing systems maintained by one or more different entities.

Additionally, each virtual warehouse is shown in FIG. 3 as having multiple execution nodes. The multiple execution nodes associated with each virtual warehouse can be implemented using multiple computing systems at multiple geographic locations. For example, an instance of virtual warehouse 1 implements execution nodes 302-1 and 312-1 on one computing platform at a geographic location and implements execution node 322-1 at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 110 is also fault tolerant. For example, if one virtual warehouse fails, that virtual warehouse is quickly replaced with a different virtual warehouse at a different geographic location. A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses can be deleted when the resources associated with the virtual warehouse are no longer useful.

In some examples, the virtual warehouses may operate on the same data in cloud storage platform 104, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance.

FIG. 4 is a block diagram 400 illustrating components of the stable object index service 109, in accordance with some examples. As is shown in FIG. 4, the stable object index service 109 includes an object manager 440, a stability manager 445, and a stable object index manager 480. As is shown in FIG. 4, the stable object index service 109 identifies objects stored on the cloud data platform 102 that meet stableness criteria. These objects that are identified are marked as stable objects and are used by the stable object index service 109 to generate a set of metrics representing performance of the stable objects.

The object manager 440 manages changes to the objects on the cloud data platform 102, as well as changes to the cloud data platform 102, such as updates, performance features, service changes, and the like. The object manager 440, or components thereof, distinguish, manage, and control, for the set or collection of stable objects, performance issues caused by user workloads and performance issues caused by new features and/or optimization to the cloud data platform or systems therein.

As used herein, the term “workload” can indicate one or more tasks, queries, requests, logical units of work, virtual warehouse operations, and the like that can be executed in the cloud data platform 102, although additional cloud-based workloads can be incorporated. The stable object index manager 480 provides integration with additional services, such as data visualization, workload management, and business intelligence platforms.

The object manager 440 manages metrics that are used to monitor, measure, and examine the objects stored in the cloud data platform 102 and characterizes such objects as stable objects or not. The stable object index manager 480 can then measure performance of systems, workloads, queries, applications, and the like running in a production environment of the cloud data platform for these stable objects. For example, production metrics can include resource utilization, response time, availability metrics, such as failure rates, throughput, scaling, and others. Metrics can also include workload metrics, query metrics, warehouse metrics, pipeline metrics, etc. For example, query execution time, query concurrency, query throughput, data scanned, data returned, and the like. These metrics can provide insights into the health, efficiency, and/or status of the cloud data platform as well as insights into the health, efficiency, and/or status of workloads in production on the cloud data platform.

Metrics for cloud data platforms typically include measures of throughput, scalability, reliability, cost, and the like. For example, throughput can be a measure of how much data a platform can process in a given time, such as queries per second, data process per second, etc. Scalability can be a measure of how well a platform can manage increasing workloads, such as by adding more nodes or processing units. Reliability can be a measure of how consistently a platform can deliver its services, such as by maintaining a high uptime and providing fast response times for queries. Cost can be a measure of how much it costs to use the platform, which can include factors such as storage and compute costs, as well as fees or charges for using the platform's services.

The stable object index service 109 further includes the stability manager 445 to determine stable data sources from which to calculate the performance index. More specifically, the stability manager 445 identifies candidate objects to determine stable objects. The stability manager 445 uses a plurality of stableness criteria that is applied across a collection or plurality of objects in the cloud data platform 102 to identify the set of stable objects. For example, the stableness criteria can include or represent objects whose composition either stays stable, or changes with a stable rate over an extended period of time. Stable objects can be defined in terms of their composition (including DML) of the tables rather than usage (e.g., SELECT queries) of the tables.

In some cases, the stability manager 445 uses metrics that measure both the static composition (e.g., the size of the object, such as the table) and dynamic properties (e.g., the rate of change of the object, such as the table) to identify stable objects. Usage statistics can then be used to check whether the stable objects are representative of objects more generally. Stability of the objects can be recognized and defined from many different perspectives. An object that is stable in certain dimensions may not exhibit stability in other dimensions. However, this does not mean that stable objects should be restricted to those objects that exhibit stability across all important dimensions. Different use cases can require different dimensions to control for stability, where it can be expected that some other dimensions would become unstable due to the factor to be measured against.

Some key dimensions of stability can be considered by the stability manager 445 in searching for an identifying stable object. The stability manager 445 considers logical and physical metrics. Logical metrics can capture the intent of the customer on how the object/table should change. For example, the number of DML jobs or number of rows intended to be inserted. Physical metrics can capture the actual underlying physical implementation of the objects. For example, the number of rows physically inserted, including write amplification. Physical metrics are more numerous and easier to obtain, but logical metrics are more useful because they more directly capture customer expectations. By default, stable object definition uses the logical metrics on objects to identify stable objects. However, there are some cases where physical metrics can be more meaningful, such as when measuring write amplification from auto-clustering operations.

The stability manager 445 can consider changing stable objects when finding stable objects. These objects have a volume of change that stays roughly the same over time. Namely, the derivative of the change stays stable over a specified period of time. The changing stable objects can be identified by the stability manager 445 based on a coefficient of variation. The coefficient of variation can be defined as the ratio of the standard deviation to the average. For example, the stability manager 445 can compute the coefficient of variation (CV) of the number of rows inserted for each object or table. The stable object index service 109 can calculate the daily total rows inserted in a given object, calculate the average of the daily totals, calculate the standard deviation of the daily totals and compute the ratio of the standard deviation to the average. This can be performed for each object or table to generate or compute the coefficient of variation for each object or table. Any object having the coefficient of variation that meets a specified threshold can be characterized or identified as a stable object. In certain cases, different categories or classifications of stability can be associated with each stable object by comparing the coefficient of variation to different thresholds, each associated with a respective category or classification.

In some examples, the stability manager 445 can compute or determine, as one of the stableness criteria, a table size based stableness attribute, criterion, or dimension (also referred to as the table size criterion). This criterion can include multiple dimensions along which the object can be classified into different stability categories. The dimensions can include a growth rate of the number of rows dimension, a variation in the growth rate dimension, and a size in terms of the number of rows of the table dimension. A given table could have a slow overall growth rate (e.g., it grows slowly on average), but nonetheless the growth could be uneven, e.g., some days the table spikes up, and other days it spikes down, but on average it grows slowly.

The stability manager 445 can compute the growth rate for each object indicating whether the object is growing quickly or slowly. For each date or day within a specified time period, the stability manager 445 analyzes the net change in the number of rows of the table over the preceding seven days or other consecutive time period. The stability manager 445 then classifies each table according to the order of magnitude of this growth. In some cases, the stability manager 445 classifies the table or object (table and object can be used interchangeably) into one of the following categories based on the respective thresholds. Zero growth meaning that the growth rate is zero; increase of up to 1 k rows (e.g., a first category corresponding to the growth rate exceeding a 1 k threshold); increase of 1 k to 1M rows (e.g., a second category corresponding to the growth rate falling between two thresholds—1 k and 1M rows); increase of 1M to 1 B rows (e.g., a third category corresponding to the growth rate falling between two thresholds—1M and 1 B rows); increase greater than 1 B rows (e.g., a fourth category corresponding to the growth rate exceeding a threshold of 1 B rows); decrease of up to 1 k rows (e.g., a fifth category corresponding to the growth rate falling below a threshold of 1 k rows); decrease of 1M to 1 B rows (e.g., a sixth category corresponding to the growth rate falling between two thresholds); and/or decrease greater than 1 B rows.

The stability manager 445 can compute the variation in the growth rate by analyzing the differences in row counts for consecutive days, and checking if the daily differences have large variation or small variation. For example, if a table grows by 1000 rows each day, then the daily differences in row counts are all exactly equal to one thousand, so the standard deviation of these daily differences is zero. For a table that grows by one thousand rows one day, then shrinks by one million rows the next day, then grows by 10 k rows the following day. For this table, the variation in daily differences is large. To quantify the variation in the growth rate, the stable object index service 109 can look at the coefficient of variation of the daily differences in numbers of table rows. Coefficient of variation can be computed by the stability manager 445 as the ratio of the standard deviation to the average. Specifically, for each date, the stability manager 445 can look at the coefficient of variation of the daily differences over the past seven days or other specified time period. The stability manager 445 can classify the object/table according to the order of magnitude of the number of rows on any given day/date and can assign a respective category based on that order of magnitude.

Stable objects can be automatically detected based on object metrics/information (e.g., size and/or growth information) and are further divided into subcategories, such as drill-down dimensions, to provide more detailed stability understanding. The stable object index service 109 further makes use of stable objects to isolate and differentiate performance changes caused by the cloud data platform 102 from workload changes associated with the customer workload for different categories of stable objects.

In some examples, the stability manager 445 can compute a table churn criterion as one of the stableness criteria. The stability manager 445 can compute churn for each object as a function of (#rows inserted+#rows deleted)/(total #rows) over a specified time period. The stable object index service 109 can then classify or categorize the objects based on their respective table churn criterion or metric, such as the fraction of churn consisting of insert operations versus delete operations. The table churn criterion can be used to classify the objects into two axes or more, such as the amount of churn which is computed based on the number of rows inserted and/or deleted and the fraction of churn that consists of inserts.

The sub-categorization enables the stable object index service 109 to further investigate how performance improvements relate to these axes. This can be done by looking at stratified samples to measure performance according to degree of churn and fraction of inserts. For example, for benchmarking the stable object index service 109 can be interested in looking at “stable” objects with low churn, whereas for other use cases like Faster DML, the stable object index service 109 can be interested in looking at the higher-churn categories as well.

The stability manager 445 can categorize the objects into different churn categories based on thresholds associated with each churn category. For example, the stability manager 445 can classify each object into one of the following categories: zero churn (e.g., a first churn category corresponding to the amount of churn or fraction of churn being zero); low churn: fraction of churned rows less than 0.01 (e.g., a second churn category corresponding to the amount of churn or fraction of churn being below a first threshold); medium churn: fraction of churned rows between 0.01 and 0.8 (e.g., a third churn category corresponding to the amount of churn or fraction of churn being between two thresholds); and high churn: fraction of churned rows greater than 0.08 (e.g., a fourth churn category corresponding to the amount of churn or fraction of churn being greater than a given threshold).

In some examples, the stability manager 445 associates the objects with different categories based on fraction of inserts defined by the (#rows inserted)/(#rows inserted+#rows deleted). The different categories can correspond to: shrinking: fraction of inserts less than 0.499 (e.g., the table is shrinking); stable: fraction of inserts between 0.499 and 0.501; growing: fraction of inserts between 0.501 and 0.99; and high: fraction of churns or inserts greater than 0.99.

In some cases, the stability manager 445 restricts the tables that are considered for stability to those with at least ten average daily select queries, so as to exclude tables that are not actually used.

To provide continual tracking, the stable object index service 109 incrementally compares stable objects using adjacent time periods when tracking stability trends over lengthy periods of time. The stable object index service 109 uses narrow and adjacent comparison windows (e.g., daily granularity), such that there are a large number of overlapping stable objects that can be used to measure the relative performance. The stable objects or group of stable objects can evolve over time and the stable object index service 109 can add and/or remove objects to/from an existing set of identified stable objects as new stable objects are discovered and as current stable objects change and may or may not satisfy stableness criteria as they change.

Providing different dimensions or categories of stability for different metrics allows customers or users to explore data in greater detail and view performance data on specific components of the cloud data platform (e.g., as opposed to the performance of the platform as a whole). For example, indexes can be created to manage the performance monitoring for a subset of components of the cloud data platform relating to stable objects. The indexes can be, for example, groups of deployments, customer accounts, system components (e.g., compute service manager 108, execution platform 110, etc.), workload classifications (e.g., data warehouse, data engineering, data science, data application, etc.), statement types (e.g., Data Definition Language (DDL), Structure Query Language (SQL), Data Manipulation Language (DML), etc.), warehouses (e.g., which warehouses are running), recurrent queries (e.g., which queries are running), resource types within a compute cluster (e.g., CPU, I/O, network, idleness, etc.) and operator types (e.g., the type of execution operator in the execution plan), parameter value, release version, and the like.

In additional examples, the stable object index service 109 leverages performance index data to perform customized analyses. Including implementing and collecting feature specific data and joining the feature-specific data with performance index service-provided views to derive insights. The stable object index service 109 is illustrated as a distinct component of the cloud data platform 102; however, additional examples of the stable object index service 109 can be implemented by any of the virtual warehouses of the execution platform 110, such as the execution node 302-1, compute service manager 108, and/or the request processing service 208, in accordance with some examples of the present disclosure.

For example, the stable object index service 109 can use the stable objects to build tracking indexes. These can be used for understanding trends over time, and identifying improvements and regressions. Specifically, the stable object index service 109 can expand the query coverage of existing performance indices, such as for both SELECT and DML statements. The stable object index service 109 can increase the coverage by incorporating jobs based on stable objects and confirming that the index remains stable after including the stable objects.

In some cases, the stable object index service 109 can index serverless services that operate on the stable objects. This can be done by identifying stable objects that are serverless services enabled (e.g., Auto Clustering, Materialized View/Search Optimization Maintenance). The stable object index service 109 can build indexes for each of these services to measure their efficiency and performance. The stable object index service 109 can generate indexes that are built on top of stable objects to provide stable measurements for certain components and areas of functionality, such as DML storage and performance, scan and pruning performance, and accelerations of individual table fragments. For example, the efficiency of a serverless service that operates on stable objects can be measured in the following ways: write amplification and efficiency of the compute services.

Write Amplification can be defined in a few different ways that measure different aspects of the service. For example, the write amplification can be measured by comparing physical metrics, such as based on the ratio of churn size produced by the background maintenance services divided by the churn size from DMLs initiated by the customers. The write amplification can be measured as a ratio between the physical churned rows from the background services to the logical churned rows from customer-initiated DMLs. The efficiency of the service can be measured by the ratio between the total amount of resources required for performing the serverless Service and the amount of work performed. The resource consumption could also be measured in several ways including credits charged to customers for maintaining the stable object and actual resources used by the jobs. The effectiveness of these serverless services can be measured in various ways including overall query performance, performance in specific areas, such as pruning, and value of queries. In addition to reducing variation in the metric, indexes built on top of stable objects also enhance the ability to detect regressions, because, for example, if the stable object index service 109 detects a spike in background cost for objects that have zero DML, then the stable object index service 109 has identified an issue that needs to be investigated.

Stable objects can also be used to build indexes for feature areas such as scanning and pruning. Certain key metrics, such as pruning effectiveness, are only meaningful when compared against themselves; but they are not comparable across tables since the optimal value would depend on the Table and Query. Such metrics can be tracked using an index on top of both stable objects and stable recurrent queries. After isolating for stable objects and recurrent queries, the metrics that can be used to track scan and pruning performance include Pruning “north-star”: percentage of rows remaining after filtering; number of rows/files remaining after each pruning stage; and scan performance over the same stable objects with same pruning selectivity.

During the design phase of certain database features, the stable objects can be used to quickly provide interesting categories of objects to analyze. This enables developers to understand the impact of creating new features and understand the expected performance characteristics. The stable objects can then be used to monitor performance of these features after making the features available to users on the cloud data platform 102.

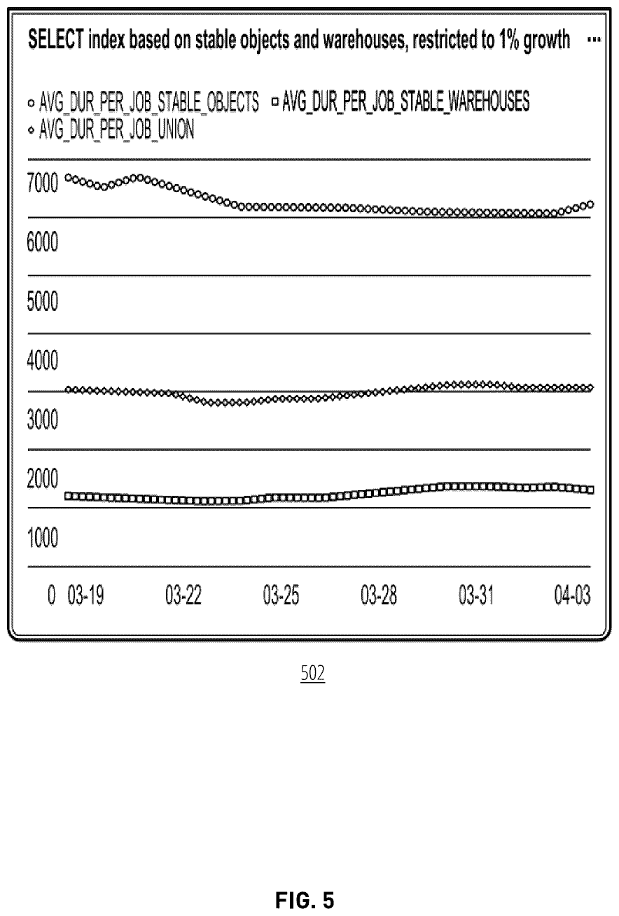

The stable object index service 109 can also generate benchmarks over extended periods of time. A subset of the stable objects (e.g. those that are very stable and observe minimal changes over time—stable objects that are in a first stability category of multiple stability categories) can be used for internal benchmarking. Using different categories of stability, the stable object index service 109 can generate different types of metrics that can be used to test current features and deploy new features. The stable object index service 109 can provide a user interface that represents outputs of the metrics based on user input that selects one or more stability categories and/or metrics, as shown in the diagram 502 of FIG. 5.

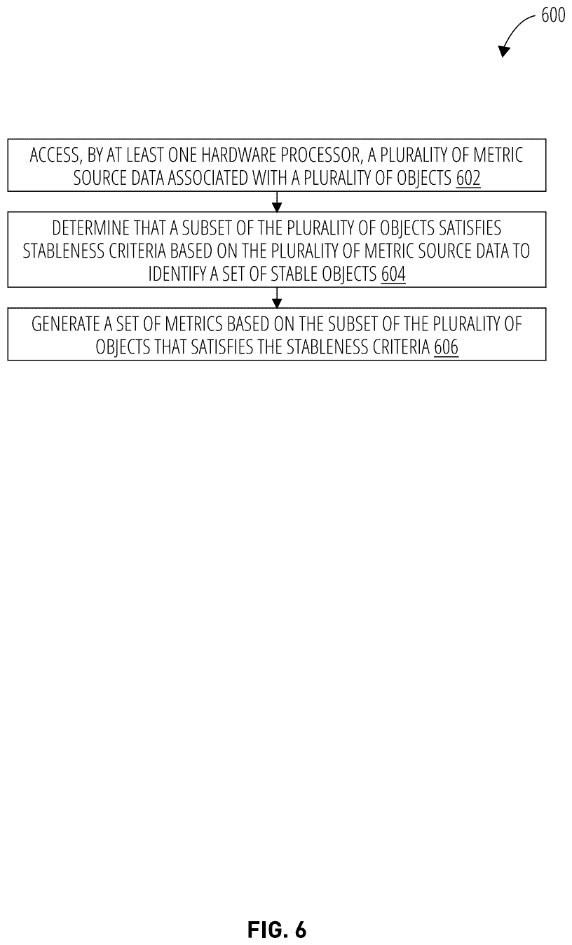

FIG. 6 illustrates a routine (method or process) in accordance with one example. The operations discussed in FIG. 6 can be performed by the stable object index service 109. In operation 602, the stable object index service 109 accesses, by at least one hardware processor, a plurality of metric source data associated with a plurality of objects. In operation 604, stable object index service 109 determines that a subset of the plurality of objects satisfies stableness criteria based on the plurality of metric source data to identify a set of stable objects. In operation 606, the stable object index service 109 generates a set of metrics based on the subset of the plurality of objects that satisfies the stableness criteria.

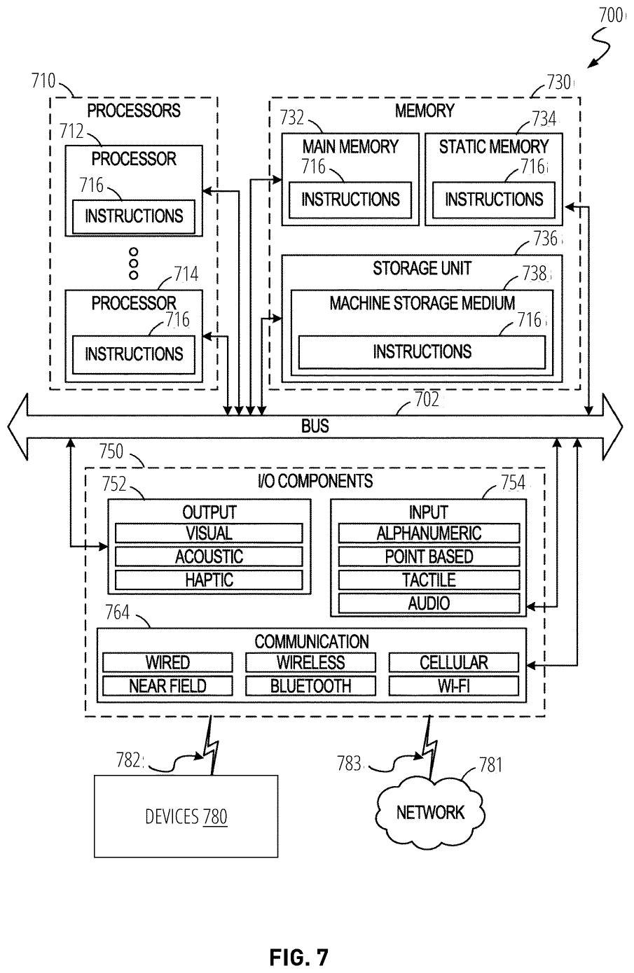

FIG. 7 illustrates a diagrammatic representation of a machine 700 in the form of a computer system within which a set of instructions can be executed for causing the machine 700 to perform any one or more of the methodologies discussed herein, according to an example. Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein can be executed. For example, the instructions 716 may cause the machine 700 to execute any one or more operations of any one or more of the methods described herein. As another example, the instructions 716 may cause the machine 700 to implement portions of the data flows described herein. In this way, the instructions 716 transform a general, non-programmed machine into a particular machine 700 (e.g., the compute service manager 108, the execution platform 110, the stable object index service 109, client device 114) that is specially configured to carry out any one of the described and illustrated functions in the manner described herein.

In alternative examples, the machine 700 operates as a standalone device or can be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

The machine 700 includes processors 710, memory 730, and input/output (I/O) components 750 configured to communicate with each other such as via a bus 702. In an example, the processors 710 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 712 and a processor 714 that may execute the instructions 716. The term “processor” is intended to include multi-core processors 710 that may comprise two or more independent processors (sometimes referred to as “cores”) that may execute instructions 716 contemporaneously. Although FIG. 7 shows multiple processors 710, the machine 700 may include a single processor with a single core, a single processor with multiple cores (e.g., a multi-core processor), multiple processors with a single core, multiple processors with multiple cores, or any combination thereof.

The memory 730 may include a main memory 732, a static memory 734, and a storage unit 736, all accessible to the processors 710 such as via the bus 702. The main memory 732, the static memory 734, and the storage unit 736 comprising a machine storage medium 738 may store the instructions 716 embodying any one or more of the methodologies or functions described herein. The instructions 716 may also reside, completely or partially, within the main memory 732, within the static memory 734, within the storage unit 736, within at least one of the processors 710 (e.g., within the processor's cache memory), or any suitable combination thereof, during execution thereof by the machine 700.

The I/O components 750 include components to receive input, provide output, produce output, transmit information, exchange information, capture measurements, and so on. The specific I/O components 750 that are included in a particular machine 700 will depend on the type of machine. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion and the grouping is in no way limiting. In various examples, the I/O components 750 may include output components 752 and input components 754. The output components 752 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 754 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication can be implemented using a wide variety of technologies. The I/O components 750 may include communication components 764 operable to couple the machine 700 to a network 781 via a coupling 783 or to devices 780 via a coupling 782. For example, the communication components 764 may include a network interface component or another suitable device to interface with the network 781. In further examples, the communication components 764 may include wired communication components, wireless communication components, cellular communication components, and other communication components to provide communication via other modalities. The devices 780 can be another machine or any of a wide variety of peripheral devices (e.g., a peripheral device coupled via a universal serial bus (USB)). For example, as noted above, the machine 700 may correspond to any one of the client devices 114, the compute service manager 108, the execution platform 110, and the devices 780 may include any other of these systems and devices.

The various memories (e.g., 730, 732, 734, and/or memory of the processor(s) 710 and/or the storage unit 736) may store one or more sets of instructions 716 and data structures (e.g., software) embodying or utilized by any one or more of the methodologies or functions described herein. These instructions 716, when executed by the processor(s) 710, cause various operations to implement the disclosed examples.

As used herein, the terms “machine-storage medium,” “device-storage medium,” and “computer-storage medium” mean the same thing and can be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium”discussed below.

In various examples, one or more portions of the network 781 can be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 781 or a portion of the network 781 may include a wireless or cellular network, and the coupling 783 can be a Code Division Multiple Access (CDMA) connection, a Global System for Mobile communications (GSM) connection, or another type of cellular or wireless coupling. In this example, the coupling 783 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 716 can be transmitted or received over the network 781 using a transmission medium via a network interface device (e.g., a network interface component included in the communication components 764) and utilizing any one of a number of well-known transfer protocols (e.g., hypertext transfer protocol (HTTP)). Similarly, the instructions 716 can be transmitted or received using a transmission medium via the coupling 782 (e.g., a peer-to-peer coupling) to the devices 780. The terms “transmission medium” and “signal medium” mean the same thing and can be used interchangeably in this disclosure. The terms “transmission medium” and “signal medium” shall be taken to include any intangible medium that is capable of storing, encoding, or carrying the instructions 716 for execution by the machine 700, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

In view of the disclosure above, various examples are set forth below. It should be noted that one or more features of an example, taken in isolation or combination, should be considered within the disclosure of this application.

Example 1. A method comprising: accessing, by at least one hardware processor, a plurality of metric source data associated with a plurality of objects; determining that a subset of the plurality of objects satisfies stableness criteria based on the plurality of metric source data to identify a set of stable objects; and generating a set of metrics based on the subset of the plurality of objects that satisfies the stableness criteria.

Example 2. The method of Example 1, wherein the plurality of metric source data indicates the number of rows added to each of the plurality of objects over a specified time period.

Example 3. The method of any one of Examples 1-2, wherein the plurality of metric source data indicates the number of rows deleted from each of the plurality of objects over the specified time period.

Example 4. The method of any one of Examples 1-3, wherein the stableness criteria comprises a table size criterion and a table churn criterion.

Example 5. The method of any one of Example 1-4, further comprising: determining that an individual object of the subset of the plurality of objects satisfies the table size criterion based on a plurality of dimensions.

Example 6. The method of any one of Examples 1-5, wherein the plurality of dimensions comprises a growth rate dimension, a variation in the growth rate dimension, and a size of the object dimension, the size of the object dimension representing a magnitude of a number of rows on any given day during the specified time period.

Example 7. The method of any one of Examples 1-6, further comprising: computing the growth rate dimension of the individual object as a function of a net change in a number of rows of the individual object over the specified time period; and classifying the individual object into an individual category of a plurality of growth categories based on the computed growth rate dimension.

Example 8. The method of any one of Examples 1-7, further comprising: computing the variation in the growth rate dimension based on a coefficient of variation of daily differences in the change in the number of rows.

Example 9. The method of any one of Examples 1-8, further comprising: computing a total number of rows inserted on each day of the specified time period; computing an average of the total number of rows inserted on each day of the specified time period; computing a standard deviation of the total number of rows inserted on each day of the specified time period; and computing a ratio of the standard deviation to the average to compute the coefficient of the variation of the daily differences in the change in the number of rows.

Example 10. The method of any one of Examples 1-9, further comprising: determining that the individual object is a stable object in response to determining that an amount of the growth rate dimension is below a first threshold and the variation in the growth rate dimension is below a second threshold, wherein different orders of magnitude is used to categorize the individual object based on the size of the object dimension.

Example 11. The method of any one of Examples 1-10, further comprising: determining that an individual object of the subset of the plurality of objects satisfies the table churn criterion based on a number of rows inserted versus number of rows deleted over the specified time period.

Example 12. The method of any one of Examples 1-11, further comprising: classifying churn of the individual object based on an amount of churn value and a fraction of churn value.

Example 13. The method of any one of Examples 1-12, further comprising: computing the amount of churn value by determining how many rows were inserted and how many rows were deleted from the object; and computing the fraction of churn value based on a number of rows that were inserted divided by a total of the number of rows that were inserted and a number of rows that were deleted.

Example 14. The method of any one of Examples 1-13, further comprising: assigning a first churn category to the individual object in response to determining that the amount of churn value is below a first threshold; assigning a second churn category to the individual object in response to determining that the amount of churn value is between the first threshold and a second threshold; assigning a third churn category to the individual object in response to determining that the fraction of churn value is below a third threshold; and assigning a fourth churn category to the individual object in response to determining that the fraction of churn value is between the third threshold and a fourth threshold.

Example 15. The method of any one of Examples 1-14, further comprising causing a portion of the set of metrics to be displayed in a user interface.

Example 16. The method of any one of Examples 1-15, wherein each stable object in the set of stable objects includes a composition that remains stable or changes at a stable rate over a specified time period.

Example 17. The method of any one of Examples 1-16, further comprising: generating a set of indexes as the set of metrics to represent functions of a database system; and identifying categories of the plurality of objects for generating new features in the database system.

Example 18. The method of any one of Examples 1-17, further comprising: generating a set of benchmarks for a database system based on the set of metrics.

Example 19. A system comprising: one or more hardware processors of a machine; and at least one memory storing instructions that, when executed by the one or more hardware processors, cause the system to perform operations comprising: accessing a plurality of metric source data associated with a plurality of objects; determining that a subset of the plurality of objects satisfies stableness criteria based on the plurality of metric source data to identify a set of stable objects; and generating a set of metrics based on the subset of the plurality of objects that satisfies the stableness criteria.

Example 20. A machine-readable storage device embodying instructions that, when executed by a machine, cause the machine to perform operations comprising: accessing a plurality of metric source data associated with a plurality of objects; determining that a subset of the plurality of objects satisfies stableness criteria based on the plurality of metric source data to identify a set of stable objects; and generating a set of metrics based on the subset of the plurality of objects that satisfies the stableness criteria.

Described implementations of the subject matter can include one or more features, alone or in combination as illustrated below by way of example. Each of these non-limiting examples can stand on its own or can be combined in various permutations or combinations with one or more of the other examples. The following examples detail certain aspects of the present subject matter to solve the challenges and provide the benefits discussed herein.

The terms “machine-readable medium,” “computer-readable medium,” and “device-readable medium” mean the same thing and can be used interchangeably in this disclosure. The terms are defined to include both machine-storage media and transmission media. Thus, the terms include both storage devices/media and carrier waves/modulated data signals.

The various operations of example methods described herein can be performed, at least partially, by one or more processors that are temporarily configured (e.g., by software) or permanently configured to perform the relevant operations. Similarly, the methods described herein can be at least partially processor implemented. For example, at least some of the operations of the methods described herein can be performed by one or more processors. The performance of certain of the operations can be distributed among the one or more processors, not only residing within a single machine, but also deployed across a number of machines. In some examples, the processor or processors can be located in a single location (e.g., within a home environment, an office environment, or a server farm), while in other examples the processors can be distributed across a number of locations.

Although the examples of the present disclosure have been described with reference to specific examples, it will be evident that various modifications and changes can be made to these examples without departing from the broader scope of the inventive subject matter. Accordingly, the specification and drawings are to be regarded in an illustrative rather than a restrictive sense. The accompanying drawings that form a part hereof show, by way of illustration, and not of limitation, specific examples in which the subject matter can be practiced. The examples illustrated are described in sufficient detail to enable those skilled in the art to practice the teachings disclosed herein. Other examples can be used and derived therefrom, such that structural and logical substitutions and changes can be made without departing from the scope of this disclosure. This Detailed Description, therefore, is not to be taken in a limiting sense, and the scope of various examples is defined only by the appended claims, along with the full range of equivalents to which such claims are entitled.

Such examples of the inventive subject matter can be referred to herein, individually and/or collectively, by the term “invention” merely for convenience and without intending to voluntarily limit the scope of this application to any single invention or inventive concept if more than one is in fact disclosed. Thus, although specific examples have been illustrated and described herein, it should be appreciated that any arrangement calculated to achieve the same purpose can be substituted for the specific examples shown. This disclosure is intended to cover any and all adaptations or variations of various examples. Combinations of the above examples, and other examples not specifically described herein, will be apparent to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

1. A method comprising:
accessing, by at least one hardware processor, a plurality of metric source data associated with a plurality of objects;
determining that a subset of the plurality of objects satisfies stableness criteria based on the plurality of metric source data to identify a set of stable objects; and
generating a set of metrics based on the subset of the plurality of objects that satisfies the stableness criteria.

2. The method of claim 1, wherein the plurality of metric source data indicates number of rows added to each of the plurality of objects over a specified time period.

3. The method of claim 2, wherein the plurality of metric source data indicates number of rows deleted from each of the plurality of objects over the specified time period.

4. The method of claim 3, wherein the stableness criteria comprises a table size criterion and a table churn criterion.

5. The method of claim 4, further comprising:
determining that an individual object of the subset of the plurality of objects satisfies the table size criterion based on a plurality of dimensions.

6. The method of claim 5, wherein the plurality of dimensions comprises a growth rate dimension, a variation in the growth rate dimension, and a size of the object dimension, the size of the object dimension representing a magnitude of a number of rows on any given day during the specified time period.

7. The method of claim 6, further comprising:
computing the growth rate dimension of the individual object as a function of a net change in a number of rows of the individual object over the specified time period; and
classifying the individual object into an individual category of a plurality of growth categories based on the computed growth rate dimension.

8. The method of claim 7, further comprising:
computing the variation in the growth rate dimension based on a coefficient of variation of daily differences in the change in the number of rows.

9. The method of claim 8, further comprising:
computing a total number of rows inserted on each day of the specified time period;
computing an average of the total number of rows inserted on each day of the specified time period;
computing a standard deviation of the total number of rows inserted on each day of the specified time period; and
computing a ratio of the standard deviation to the average to compute the coefficient of the variation of the daily differences in the change in the number of rows.

10. The method of claim 8, further comprising:
determining that the individual object is a stable object in response to determining that an amount of the growth rate dimension is below a first threshold and the variation in the growth rate dimension is below a second threshold, wherein different orders of magnitude is used to categorize the individual object based on the size of the object dimension.

11. The method of claim 4, further comprising:
determining that an individual object of the subset of the plurality of objects satisfies the table churn criterion based on a number of rows inserted versus number of rows deleted over the specified time period.

12. The method of claim 11, further comprising:
classifying churn of the individual object based on an amount of churn value and a fraction of churn value.

13. The method of claim 12, further comprising:
computing the amount of churn value by determining how many rows were inserted and how many rows were deleted from the object; and
computing the fraction of churn value based on a number of rows that were inserted divided by a total of the number of rows that were inserted and a number of rows that were deleted.

14. The method of claim 13, further comprising:
assigning a first churn category to the individual object in response to determining that the amount of churn value is below a first threshold;
assigning a second churn category to the individual object in response to determining that the amount of churn value is between the first threshold and a second threshold;
assigning a third churn category to the individual object in response to determining that the fraction of churn value is below a third threshold; and
assigning a fourth churn category to the individual object in response to determining that the fraction of churn value is between the third threshold and a fourth threshold.

15. The method of claim 1, further comprising causing a portion of the set of metrics to be displayed in a user interface.

16. The method of claim 1, wherein each stable object in the set of stable objects includes a composition that remains stable or changes at a stable rate over a specified time period.

17. The method of claim 1, further comprising:
generating a set of indexes as the set of metrics to represent functions of a database system; and
identifying categories of the plurality of objects for generating new features in the database system.

18. A system comprising:
one or more hardware processors of a machine; and
at least one memory storing instructions that, when executed by the one or more hardware processors, cause the system to perform operations comprising:
accessing a plurality of metric source data associated with a plurality of objects;
determining that a subset of the plurality of objects satisfies stableness criteria based on the plurality of metric source data to identify a set of stable objects; and
generating a set of metrics based on the subset of the plurality of objects that satisfies the stableness criteria.

19. The system of claim 18, wherein the plurality of metric source data indicates number of rows added to each of the plurality of objects over a specified time period.

20. The system of claim 19, wherein the plurality of metric source data indicates number of rows deleted from each of the plurality of objects over the specified time period.

21. The system of claim 20, wherein the stableness criteria comprises a table size criterion and a table churn criterion.

22. The system of claim 21, the operations comprising:
determining that an individual object of the subset of the plurality of objects satisfies the table size criterion based on a plurality of dimensions.

23. The system of claim 22, wherein the plurality of dimensions comprises a growth rate dimension, a variation in the growth rate dimension, and a size of the object dimension, the size of the object dimension representing a magnitude of a number of rows on any given day during the specified time period.

24. The system of claim 23, the operations comprising:
computing the growth rate dimension of the individual object as a function of a net change in a number of rows of the individual object over the specified time period; and
classifying the individual object into an individual category of a plurality of growth categories based on the computed growth rate dimension.

25. The system of claim 24, the operations comprising:
computing the variation in the growth rate dimension based on a coefficient of variation of daily differences in the change in the number of rows.

26. The system of claim 25, the operations comprising:
computing a total number of rows inserted on each day of the specified time period;
computing an average of the total number of rows inserted on each day of the specified time period;
computing a standard deviation of the total number of rows inserted on each day of the specified time period; and
computing a ratio of the standard deviation to the average to compute the coefficient of the variation of the daily differences in the change in the number of rows.

27. The system of claim 25, the operations comprising:
determining that the individual object is a stable object in response to determining that an amount of the growth rate dimension is below a first threshold and the variation in the growth rate dimension is below a second threshold, wherein different orders of magnitude is used to categorize the individual object based on the size of the object dimension.

28. The system of claim 21, the operations comprising:
determining that an individual object of the subset of the plurality of objects satisfies the table churn criterion based on a number of rows inserted versus number of rows deleted over the specified time period.

29. The system of claim 18, the operations comprising:
generating a set of indexes as the set of metrics to represent functions of a database system; and
identifying categories of the plurality of objects for generating new features in the database system.

30. A machine-readable storage device embodying instructions that, when executed by a machine, cause the machine to perform operations comprising:
accessing a plurality of metric source data associated with a plurality of objects;
determining that a subset of the plurality of objects satisfies stableness criteria based on the plurality of metric source data to identify a set of stable objects; and
generating a set of metrics based on the subset of the plurality of objects that satisfies the stableness criteria.
